(19) United States
(12) Patent Application Publication
(10) Pub. No.: US 2015/0321127 A1
(43) Pub. Date: Nov. 12, 2015

(54) SINK FILTER

(71) Applicant: John N. Arent, Mt. Pleasant, SC (US)

(72) Inventor: John N. Arent, Mt. Pleasant, SC (US)

(21) Appl. No.: 14/273,201

(22) Filed: May 8, 2014

(51) Int. Cl. B01D 35/02; C02F 1/00

(52) U.S. Cl. CPC B01D 35/02; C02F 1/001; C02F 2103/002

(57) ABSTRACT

A filter or strainer for a sink has an elevated body that breaks an eddy or whirlpool effect associated with sink drains, while also providing effective filtering of solid materials. The surface area of the device that is positioned above the drain allows water to pass through orifices in the body, while solid debris drops generally vertically in the sink and away from the drain. After the sink is drained of water, solid refuse can be easily removed and discarded.

### FIELD OF THE INVENTION

This invention relates to plumbing devices generally, and is more particularly directed to a strainer or filter for a sink.

### BACKGROUND OF THE INVENTION

In food service settings, used dishes and glassware are frequently emptied in a sink prior to being placed in a dishwasher. Particularly in bar settings, used glasses are emptied into a bar sink before being placed in a dishwasher to be washed and sanitized. The refuse from glasses commonly comprises solid materials such as ice cubes, mixing straws and fruit slices, all of which is thrown into a sink.

The faucet of the sink is turned on to melt the ice and eliminate or reduce the quantity of ice in the sink that interferes with the capacity of the sink. The eddy current or whirlpool effect caused by water being pulled toward and down into the drain also forces the solid refuse into the drain. The refuse collects in the drain pipe and in the p-trap, resulting in clogging of the drain and trap, and restricting water flow through the drain system.

These clogs result in sink overflows and work interruptions. The material clogging the drain is often extremely difficult to remove, requiring assistance from a professional plumber.

There is a need for a device that is easy to install and easy to use that will prevent drain clogging in food service and bar settings. The device should not materially interfere with normal use of the drain.

### SUMMARY OF THE INVENTION

The present invention is a filter or strainer for a sink. An elevated main body having a plurality of orifices in an outer enclosure breaks an eddy or whirlpool effect of the drain, while also providing effective filtering of solid materials. The surface area of the strainer that is positioned above the drain allows water to pass through the orifices at a metered pace and directly into the drain, while larger solid materials drop generally vertically in the sink as the sink empties of water. After the sink is drained of water, solid refuse can be easily removed and discarded.

### BRIEF DRAWING DESCRIPTION

FIG. 1 is a side elevation view of the strainer or filter of the invention.

FIG. 2 is a cross sectioned view of a side elevation view showing the filter or strainer of the invention installed in a bar sink drain.

FIG. 3 is a top, plan view of the upper end of the filter or strainer device having a cap fitted thereon.

FIG. 4 is a cross sectioned view of the bottom of an elastomeric lower portion of the filter or strainer device, the lower portion having a reduced diameter from the main body.

### DETAILED DESCRIPTION OF PREFERRED EMBODIMENTS

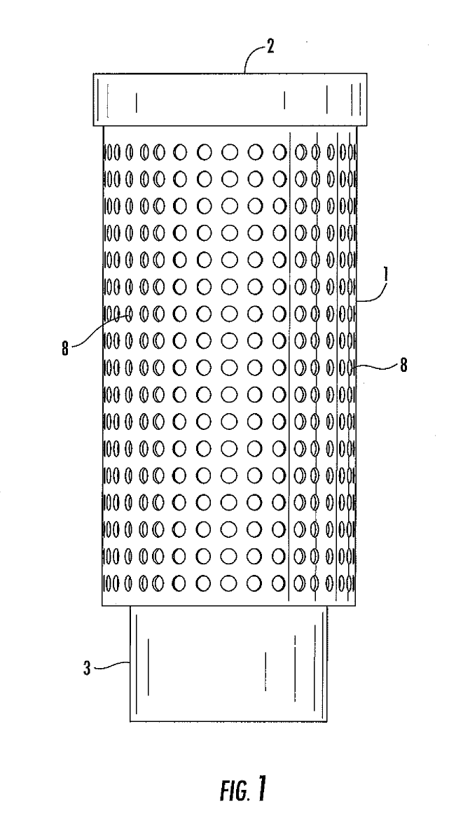

In one embodiment of the invention, as shown in FIG. 1, the filter or strainer of the invention has three main components. A main body 1 extends above a lower portion 3 of the filter or strainer. A cap 2 is positioned over the main body.

A preferred embodiment of the main body comprises an outer enclosure 4 that surrounds a hollow center 6. The hollow center forms a conduit that communicates with a drain 12 of a sink 14. The outer enclosure is preferred to fully surround the hollow central portion of the main body. The enclosure comprises a plurality of orifices 8 as shown in FIG. 1.

In a preferred embodiment, the plurality of orifices extends from an upper end of the enclosure, or substantially from an upper end of the enclosure, to the lower end of the enclosure, or substantially just above the lower portion of the filter or strainer. It is preferred that the orifices surround substantially the entire circumference or perimeter of the enclosure, from substantially the top to the bottom of the enclosure. In a preferred embodiment, the enclosure of the main body is substantially cylindrical, with the open or hollow center 6 forming a conduit to the drain. The enclosure is preferred to be formed of a non-corrosive material, which may be a durable plastic or stainless steel. In one embodiment, the outer enclosure and cap are formed of polyvinyl chloride (PVC). In most environments, plastic or PVC is preferred as being durable, and inexpensive to replace if lost or damaged.

The main body joins the lower portion 3 of the filter or strainer. The lower portion of the filter or strainer is preferred to have a central void that communicates with the central void or hollow portion of the main body so as to form a conduit between the orifices 8 and the drain of the sink.

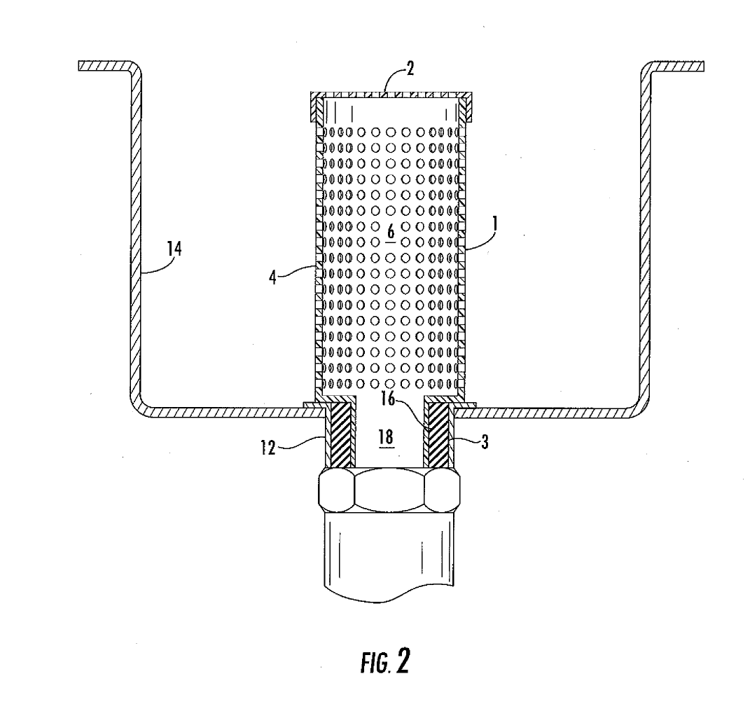

The lower portion is preferred to be cylindrical in most applications, since the openings to most drains are cylindrical. The lower portion should comprise a compressible and elastomeric outer portion or ring 10 that is constructed and arranged to be inserted into the female receptacle of the drain 12. The elastomeric material contacts the inside diameter of the drain, preferably with compression of the elastomeric material, so that the lower portion fits tightly within the opening of the drain. The outer enclosure 4 of the main body has a larger diameter or perimeter than the diameter or perimeter of the lower portion 3, so that preferably a shoulder is formed where the outer enclosure joins the lower portion. The shoulder is positioned on the bottom of the sink, to provide support for the device, and fixing the device securely to the sink. FIG. 2.

In preferred embodiments, the top of the main body extends at least ten (10 cm) centimeters above the drain opening and/or the floor of the sink. This elevation, with the orifices extending to the top and entirely around the perimeter of the enclosure, has the effect of breaking the eddy or whirlpool in water that is normally associated with sinks as they drain. By eliminating the strong vortex, eddy or whirlpool, the solid material is not pulled toward or into the drain, but rather, the solid material falls generally vertically toward the bottom floor of the sink, and in many cases, generally straight down. Since the solid material is not pulled with force toward and into the drain, clogging of the drain does not occur. Accordingly, the device does not simply provide a filter, which still could result in solid material accumulating about the surface of the filter, but rather, unlike prior art devices, tends to cause solid material to be distributed more evenly about the bottom of the sink as the sink empties, so that neither the drain nor the filter are clogged.

A preferred height of ten (10 cm) centimeters will create the desired effect of breaking the eddy or whirlpool, while a height that is not in excess of twenty (20 cm) centimeters will generally result in a device that does not interfere with normal food service functions. In most applications, a height of ten to fifteen (10-15 cm) centimeters is preferred.

In most applications, the orifices are 2.5 to 5.0 millimeters in area. Orifices of this size, which may be uniform across the surface of the outer enclosure, will filter most solid materials encountered in the food service setting that may result in drain clogging, but are not so small as to retain undesired materials. It is preferred that the plurality of orifices of the outer enclosure provide an aggregate of not less than 150 square centimeters of orifices in the enclosure, with the orifices ranging from 2.5 millimeters to 5.0 millimeters each in area. In one embodiment, the orifices each have a diameter of about 0.3 centimeters each on about 0.6 centimeter centers.

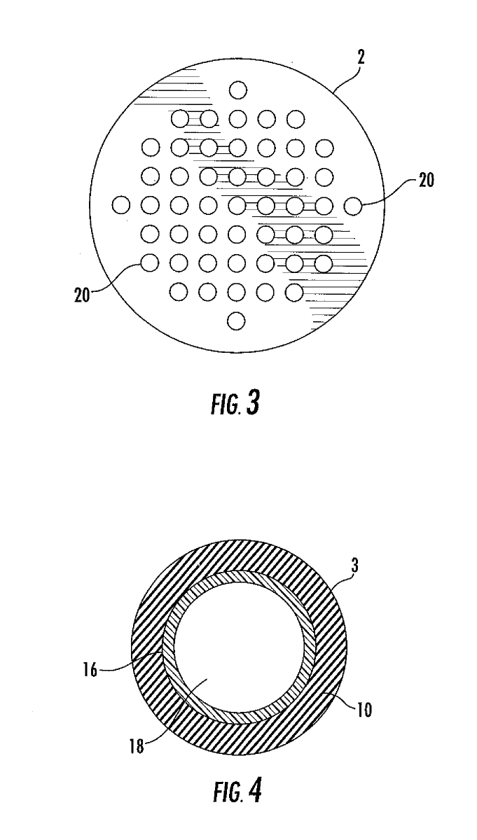

In one embodiment the outer surface or ring 10 of lower portion 3 is formed of an elastomeric and compressible material. The material may comprise rubber, or neoprene, or similar elastomeric and compressible materials. As shown in FIG. 4, an outer ring of elastomeric material may surround a core 16, which in turn surrounds a hollow center 18 that communicates with the hollow portion of the main body. The core may be formed of the same material as the outer enclosure and may extend directly from the outer enclosure. The core may be formed of a hard plastic or non-corrosive metal, such as stainless steel.

In a preferred embodiment, the device comprises a cap 2 which fits over the main body to cover the open or hollow interior of the main body. The cap may be formed of non-corrosive plastic, such as a hard plastic, or a non-corrosive metal, like the outer enclosure of the main body. The cap is preferred to form a water tight seal with the outer enclosure. The cap may be attached to the outer enclosure as shown in FIG. 2, and may be attached with an adhesive, or by welding. In a preferred embodiment, the cap fits on the outer enclosure by means of threaded engagement between the cap and the outer enclosure of the main body. The threaded engagement permits the cap to be removed if necessary to extract materials from the hollow interior portion of the main body.

As shown in FIG. 3, it is preferred that the cap comprise a plurality of orifices 20. In this way, the cap provides additional drainage, if required, due to unexpected overflow of the sink. The geometry of the orifices for the cap may be consistent in size and density with the plurality of orifices of the outer enclosure.

The resulting device eliminates common problems associated with drain clogging in food service sinks, and particularly, bar sinks. The device is formed of durable and non-corrosive materials which provide maintenance free service. The device is easy to install, and may be easily removed and replaced by unskilled persons, if necessary, to obtain access to the drain of the sink. The size of the device is such that it does not materially interfere with normal food service or bar operations.

What is claimed:

1. A strainer for a sink, comprising:
a) a main body, the main body comprising an outer enclosure; and
b) an elastomeric lower portion having a reduced diameter from the main body,
the elastomeric lower portion constructed and arranged to fit within an opening of a drain of a sink, the elastomeric lower portion constructed and arranged to contact the opening to the drain of the sink about the circumference of the lower Portion of the strainer;
wherein the outer enclosure of the main body comprises a plurality of orifices extending from substantially a top of the enclosure to substantially the elastomeric lower portion of the enclosure, and about substantially an entire circumference of the enclosure of the main body, and wherein the plurality of orifices communicate with the opening to the drain of the sink.

2. A strainer for a sink as described in claim 1, further comprising a cap, wherein the cap covers a top opening of the main body.

3. A strainer for a sink as described in claim 1, further comprising a cap, wherein the cap covers a top opening of the main body, and wherein the cap comprises a plurality of orifices therein, and wherein the plurality of orifices of the cap communicate with the opening to the drain of the sink.

4. A strainer for a sink as described in claim 1, further comprising a threaded cap, wherein the threaded cap threadably engages the main body and covers a top opening of the main body, and wherein the threaded cap comprises a plurality of orifices therein, and wherein the plurality of orifices of the cap communicate with the opening to the drain of the sink.

5. A strainer for a sink as described in claim 1, wherein outer enclosure of the main body is substantially cylindrical in shape.

6. A strainer for a sink as described in claim 1, wherein the outer enclosure extends not less than 10 centimeters above the opening to the drain of the sink.

7. A strainer for a sink as described in claim 1, wherein the a portion of the plurality of the orifices of the outer enclosure are not less than 25 millimeters in diameter and not more than 50 millimeters in diameter.

8. A strainer for a sink as described in claim 1, wherein the main body is hollow.

9. A strainer for a sink as described in claim 1, wherein the plurality of orifices provide an aggregate of not less than 150 square centimeters of orifices in the enclosure

10. A strainer for a sink as described in claim 1, wherein a portion of the plurality of the orifices of the outer enclosure are not less than 25 millimeters in diameter and not more than 50 millimeters in diameter, and wherein the plurality of orifices provide an aggregate of not less than 150 square centimeters of orifices in the enclosure.

11. A strainer for a sink as described in claim 1, wherein the main body extends not less than 10 centimeters above the opening to the drain of the sink and not more than 20 centimeters above the opening to the drain of the sink, and wherein a portion of the plurality of the orifices of the outer enclosure are not less than 2.5 millimeters in diameter and not more than 5.0 millimeters in diameter, and wherein the plurality of orifices provide an aggregate of not less than 150 square centimeters of orifices in the enclosure.
